(19) United States
(12) Patent Application Publication
(10) Pub. No.: US 2012/0205255 A1
(43) Pub. Date: Aug. 16, 2012

(54) Apparatus and Method for Disinfecting Contact Lenses

(75) Inventors: William Roster, Salem, NH (US); Hossein Zarrin, Winchester, MA (US); Carl David Lutz, Windham, NH (US); Nicholas R. Lauder, Somerville, MA (US)

(73) Assignee: ELECTROLYTIC OZONE INC., Wilmington, MA (US)

(21) Appl. No.: 13/327,688

(22) Filed: Dec. 15, 2011

Related U.S. Application Data
(60) Provisional application No. 61/423,490, filed on Dec. 15, 2010.

(51) Int. Cl. C25B 1/13; C25B 11/12; B23P 17/04; C25B 9/00

(52) U.S. Cl. 205/626; 204/242; 29/592

(57) ABSTRACT

A system and method for disinfecting contact lenses produces ozone from the water in which the contact lenses are submerged, thus avoiding the need to supply ozone from an external source. Ozone is created by an electrolytic cell including a diamond electrode, which is submerged in the water with the contact lenses to be disinfected. The diamond electrode may include a number of fingers, and may be fabricated from a diamond blank.

### PRIORITY

This patent application claims priority from provisional U.S. patent application No. 61/423,490, filed Dec. 15, 2010, entitled, “Apparatus and Method for Disinfecting Contact Lenses,” and naming William Yost; Bill Roster; Hossein Zarrin; and Phillip Vanaria as inventors, the disclosure of which is incorporated herein, in its entirety, by reference.

### Related Applications

This patent application includes similar subject matter to U.S. patent application Ser. No. 13/310,406, filed Dec. 2, 2011, entitled, “Electrolytic Cell for Ozone Production,” and naming William J. Yost III; Carl David Lutz; Jeffrey D. Booth; Donald J. Boudreau; and Nicholas R. Lauder as inventors, the disclosure of which is incorporated herein, in its entirety, by reference.

The present application is related to U.S. Application Ser. No. 61/419,574, filed Dec. 3, 2010, which application is incorporated herein, in its entirety, by reference.

### TECHNICAL FIELD

The present invention relates to contact lens cleaning, and more particularly to methods and devices for cleaning contact lenses with ozone.

### BACKGROUND ART

It is known in the prior art to disinfect contact lenses using ozone. For example, to disinfect his contact lenses, a user would place his contact lenses into a vial and pour a hydrogen peroxide solution into the vial. The hydrogen peroxide within the solution acts to disinfect the contact lenses. After the contact lenses have been disinfected, the user would remove the contact lenses from the vial and apply them to his eyes. One problem with using hydrogen peroxide is that the user must typically leave his contact lenses in the hydrogen peroxide solution for six hours. Before the user can use the contact lenses, the hydrogen peroxide in the solution must decompose. To this end, the vial includes platinum, which decomposes the hydrogen peroxide. If the user removes his contact lenses before the hydrogen peroxide is decomposed, he risks irritating his eyes with the residual hydrogen peroxide.

Other methods disinfect contact lenses also use ozone. For example, U.S. Pat. No. 5,082,558 cleans contact lenses by creating ozone in an ozone generator outside of a treatment chamber, and then pumping the ozone into the treatment chamber, where the ozone disinfects a contact lens.

### SUMMARY OF THE EMBODIMENTS

In a first embodiment there is provided a method of disinfecting a contact lens, which includes providing a chamber configured to hold a water-based liquid and to hold at least one contact lens, and configured to supply power to an electrolytic cell; providing water within the chamber; providing an electrolytic cell at least partially submerged in the water; and causing the electrolytic cell to produce ozone from at least a portion the water, the ozone dissolving in the water. In some embodiments, the step of providing an electrolytic cell includes providing an electrolytic cell having a first diamond electrode and a second electrode, and a membrane separating the first diamond electrode and the second electrode. In some embodiments, the step of causing the electrolytic cell to produce ozone from at least a portion the water includes driving a constant current between the first diamond electrode and the second electrode. More particularly, in some embodiments the current is between about 50 and 300 milliamps, and the voltage potential between the electrodes is between about 7 and 9 volts.

In some embodiments, the step of providing an electrolytic cell includes providing an electrolytic cell having a first diamond electrode and a second diamond electrode, and a membrane separating the first diamond electrode and the second electrode. Indeed, in some embodiments, the step of causing the electrolytic cell to produce ozone from at least a portion the water includes driving a constant current between the first diamond electrode and the second diamond electrode. In some embodiments, the current is between about 50 and 300 milliamps, and the voltage potential between the electrodes is between 7 and 9 volts. Further, in some embodiments, the method includes periodically reversing the direction of the current flow.

In some embodiments, the method also includes placing a contact lens into the chamber.

In another embodiment, a system for disinfecting a contact lens by creating ozone in water within a disinfecting chamber includes a chamber configures for holding a water-based liquid and at least one contact lens; an electrolytic cell within the chamber and configured to be submerged in the water-based liquid, wherein the electrolytic cell includes a first electrode and a second electrode, at least one of the first electrode and the second electrode including a diamond, and the electrolytic cell is configured to produce ozone from the water-based liquid; and a plurality of power terminals within the chamber, the plurality of power terminals coupled to the electrolytic cell. The relationship between the volume of the chamber and the ozone-producing capacity of the electrolytic cell is such that the electrolytic cell is capable of producing a concentration of ozone with the water-based liquid of at least 0.5 parts per million.

In some embodiments, at least one of the first electrode and the second electrode includes a free-standing diamond. In some embodiments, at least one of the first electrode and the second electrode includes a digitated diamond.

In some embodiments, the electrolytic cell includes a first diamond electrode and a second diamond electrode. In some embodiments, the first diamond electrode includes a first digitated diamond and the second diamond electrode includes a second digitated diamond.

In some embodiments, the system also includes a power source coupled to the plurality of terminals, the power source configured to supply power to the electrolytic cell via the plurality of terminals. In some embodiments, the power source is configured to supply a constant current to the electrolytic cell. Indeed, in some embodiments, the power source is configured to supply a constant current to the electrolytic cell of between 150 and 300 milliamps.

In yet other embodiments, the system further includes a base configured to receive the chamber, the base having a plurality of base power terminals configured to electrically connect to the power terminals within the chamber, and including control circuitry configured to supply power to the base power terminals.

In another embodiment, a method of fabricating a diamond includes providing a diamond blank having a plurality of faces, and removing at least a portion of the diamond blank, such that the remaining portion of the diamond blank includes a plurality of fingers.

In some embodiments, the method includes cutting the diamond blank into a first segment and a second segment, the first segment having a first plurality of fingers and the second segment having a second plurality of fingers, the first plurality of fingers interdigitated with the second plurality of fingers; and separating the first segment from the second segment.

In another embodiment, the step of removing at least a portion of the diamond blank includes removing at least a portion of the diamond blank such that the remaining portion of the diamond blank includes at least three fingers.

### BRIEF DESCRIPTION OF THE DRAWINGS

The foregoing features of embodiments will be more readily understood by reference to the following detailed description, taken with reference to the accompanying drawings, in which:

FIGS. 1A-1D schematically illustrate embodiments of a contact lens cleaning system;

FIGS. 2A and 2B schematically illustrate an embodiment of a contact lens treatment chamber;

FIG. 2C schematically illustrates a convection current within an embodiment of contact lens treatment chamber;

FIG. 3 schematically illustrates an embodiment of an electrolytic cell;

FIG. 4A schematically illustrates an embodiment of internal components of an electrolytic cell;

FIGS. 4B and 4C schematically illustrate embodiment s of diamond electrodes;

FIG. 5 schematically illustrates an embodiment of a diamond element;

FIG. 6 is a flow chart that illustrates a method of disinfecting a contact lens;

FIG. 7 is a flow chart that illustrates a method of fabricating a diamond element;

FIGS. 8A-8C schematically illustrate a diamond element at various points of fabrication; and

FIGS. 9A and 9B schematically illustrate embodiments of a control circuit.

### DETAILED DESCRIPTION OF SPECIFIC EMBODIMENTS

Various embodiments provide methods and devices for quickly and economically disinfecting contact lenses. For example, contact lenses may be disinfected in a matter of minutes, instead of hours as with many commonly used contact lens disinfecting products. In general, a contact lens may be disinfected by submerging the lens in water, and then producing ozone from some of the water in which the lens is submerged. The ozone then dissolves in the remaining water and, by exposure to the contact lens, disinfects the contact lens. The ozone may be created from the water by an electrolytic cell submerged in the water itself, thereby creating ozone as and where it is needed, without exposing the water or contact lens to contaminants that may accompany ozone from an external source.

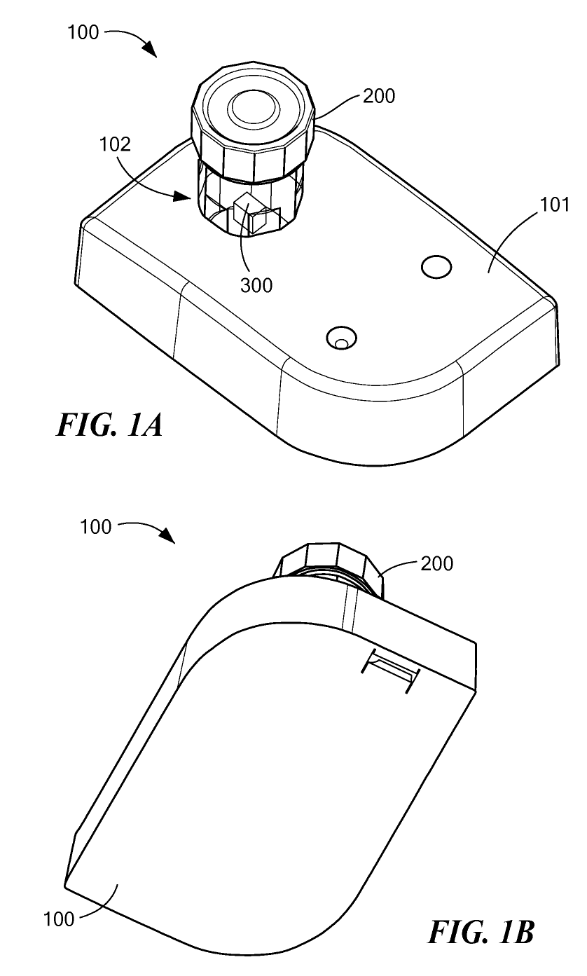

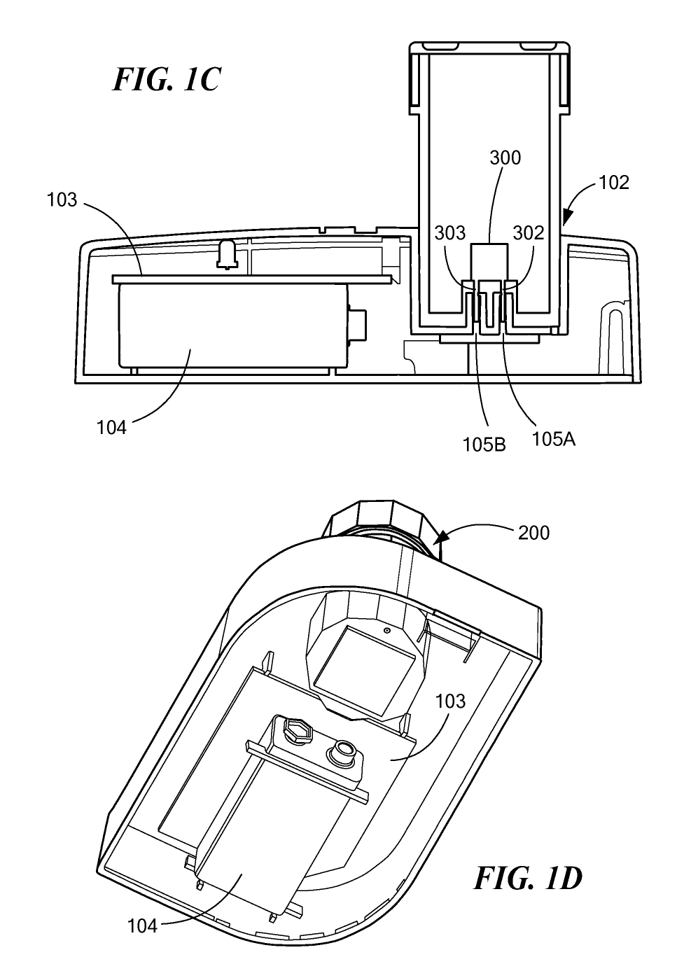

A first embodiment of a contact lens disinfecting system 100 is schematically illustrated in FIG. 1A and FIG. 1B, and includes a base 101 and a disinfecting chamber 200. FIG. 1A schematically illustrates the contact lens disinfecting system 100 in a perspective view from above, while FIG. 1B schematically illustrates the contact lens disinfecting system 100 in a perspective view from below. The disinfecting chamber 200 holds one or more contact lenses to be cleaned, while the base 101 supports the disinfecting chamber 200.

The base 101 has a length a width sufficient to be stable when placed on a flat surface, such as the surface of a table or nightstand, for example. In this embodiment 100, the base 101 includes a cavity 102 configured to receive the disinfecting chamber 200. The disinfecting chamber 200 is removable from the base 100. In some embodiments, the cavity 102 includes a plurality of power terminals to power the disinfecting chamber 200, and more specifically, an electrolytic cell 300.

In some embodiments, the base also includes various electrical elements, such as a control circuit 103 and a power supply 104. In the embodiment of FIGS. 1C and 1D for example, the power supply is a 9-volt battery, while in other embodiments the power supply could be a different configuration of one or more batteries, a transformer for producing power from an external source of alternating current, or a voltage regulator, to name but a few examples.

The disinfecting chamber 200 is configured to hold one or more contact lenses to be cleaned, and to include the above-noted electrolytic cell 300. To that end, in some embodiments, the disinfecting chamber 200 may have a volume of approximately 10 milliliters. Generally, the volume of the disinfecting chamber 200 should be such that quantity of water within the disinfecting chamber 200 is sufficient to submerge the electrolytic cell and at least one contact lens, and yet not so great as to dilute the ozone dissolved in the water to a degree that the water-ozone solution cannot disinfect two contact lenses within 5 to 20 minutes. The concentration of ozone in the water may be determined by a number of factors, including the dimensions of the diamond electrode in the electrolytic cell, the amount of power flowing through the electrolytic cell, the length of time that the electrolytic cell is operated to produce ozone. The concentration of ozone in the water may also be influenced by the water itself, for example if the water contains any impurities that react with or absorb ozone.

The relationship between the volume of the disinfecting chamber 200 and the ozone-generating capacity of electrolytic cell 300 is such that the electrolytic cell 300 is capable of producing a concentration of ozone within the water of at least 0.5 or 1 parts per million (“ppm”) within 5 or 6 minutes. If too much water is present, the electrolytic cell may not be able to generate sufficient ozone to bring the ozone concentration to a specified level. Indeed, in some embodiments, the concentration of ozone in the water reaches between 4 and 5 parts ppm, while in other embodiments that concentration may reach 6 ppm, 7 ppm, 8 ppm, 9 ppm, 10 ppm, or more.

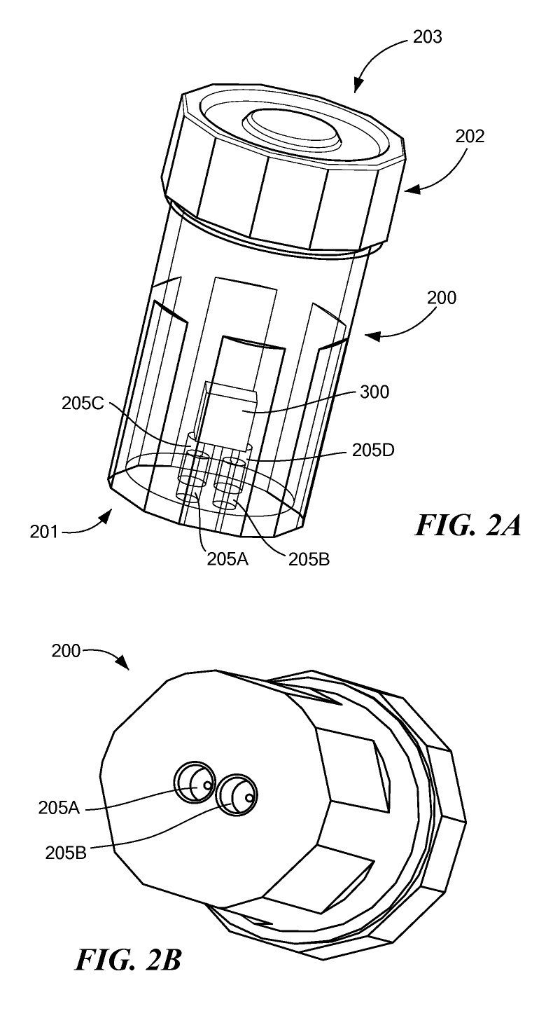

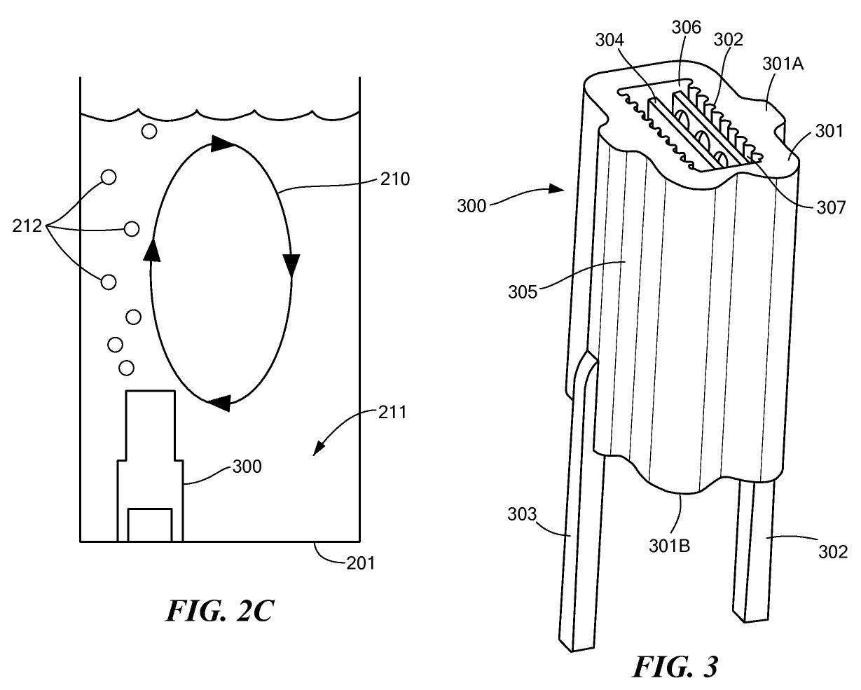

One embodiment of a disinfecting chamber 200 is schematically illustrated in FIG. 2A and FIG. 2B. The interior of the disinfecting chamber 200 includes two contacts or receptacles 205C and 205D to receive electrodes 302 and 303 from the electrolytic cell 300. In some embodiments, the receptacles 205C and 205D may form a water-tight seal with electrodes 302 and 303, while in other embodiments the receptacles 205C and 205D and/or electrodes 302 and 303 may be exposed to water 211 within the disinfecting chamber 200. The inventors recognize that water is not a perfect insulator, and therefore some current may flow through the water between the receptacles 205C and 205D, and/or between electrodes 302 and 303 when power is applied. In this sense, leaving the receptacles 205C and 205D and/or electrodes 302 and 303 exposed to water within the disinfecting chamber 200 is counterintuitive. Nevertheless, the inventors have discovered that at the relatively low voltages present at the receptacles 205C and 205D and/or electrodes 302 and 303, such current flow will not materially interfere with the operation of the electrolytic cell 300. Therefore, the receptacles 205C and 205D and/or electrodes 302 and 303 may be exposed to the water, thereby avoiding the cost and complexity of shielding them within a water-tight seal.

The electrolytic cell 300 may be selected from any of a variety of electrolytic cells, such as those described in U.S. patent application Ser. No. 13/310,406. The electrolytic cell 300 may be placed anywhere within the disinfecting chamber 200, but should be located so that it will be at least partially submerged, and may be fully submerged, when the disinfecting chamber 200 contains water 211. In the embodiment of FIG. 2A, the electrolytic cell 300 is located near the bottom 210 of the disinfecting chamber 200. Locating the electrolytic cell 300 near the bottom 210 of the disinfecting chamber 200 provides a number of advantages. For example, in such a location the electrolytic cell 300 will not interfere with placing a contact lens, or a basket holding a contact lens, into the disinfecting chamber 200 through an opening 202 at the top of the disinfecting chamber 200.

The opening 202 in FIG. 2A is not visible because the opening 202 is covered by a cap 203. In some embodiments, the cap 203 may seal the disinfecting chamber 200 such that no water may escape from within the disinfecting chamber 200, for example if the disinfecting chamber 200 is tipped or knocked-over while containing water.

On the other hand, the production of ozone by the electrolytic cell 300 may produce a gaseous hydrogen by-product. As such, it may be necessary or desirable to release or vent such gas from the disinfecting chamber 200, rather than have a volatile gas like hydrogen build-up inside. To that end, in some embodiments, the cap 203 may include a pressure-relief valve to allow a gas to escape.

The disinfecting chamber 200 may include a structure or mechanism to hold one or more contact lenses, and to submerge them. For example, the structure could be a basket, mesh, screen, or web material that supports the contact lenses, to name but a few. In another example, the mechanism might be a casing that is integral to the cap 203. In such an embodiment, the user places his contact lenses into the casing. When the cap 203 is secured to the disinfecting chamber 200, the casing submerges the contact lenses into water within the disinfecting chamber 200.

In some embodiments, the disinfecting chamber 200 includes two exterior power terminals. For example, the disinfecting chamber 200 has two such power terminals 205A and 205B located at its bottom surface 210, as schematically illustrated in FIG. 2B. The power terminals 205A and 205B are configured to mate with corresponding base terminals 105A and 105B in cavity 102. The base terminals 105A and 105B are, in turn, coupled to power supply 104, for example by conductors (not shown) such as wires for example. As such, power from power supply 104 may flow through the base terminals 105A and 105B on the base 100, and the power terminals 205A and 205B on the disinfecting chamber 200, to the receptacles 205C and 205D and thereby to the electrodes 302 and 303 of an electrolytic cell 300 within the disinfecting chamber 200 on the base 100.

In some embodiments, the electrolytic cell 300 may cause a convection flow 210 of water 211 within the disinfecting chamber 200, as schematically illustrated in FIG. 2C. Specifically, hydrogen gas created as a by-product of the electrolysis process may bubble through the water and create a mechanical current within the water. Such a flow may facilitate the diffusion of generated ozone into the water 211, and facilitate the circulation of the water-ozone solution within the disinfecting chamber 200. The circulation favorably facilitates the exposure of a contact lens to the generated ozone. In FIG. 2C, the electrolytic cell 300 is offset from the center of the bottom 201 of the disinfecting chamber 200, generating rising hydrogen bubbles near a sidewall of the disinfecting chamber 200, thereby further facilitating a convection current 210.

FIG. 3 schematically illustrates an embodiment of an electrolytic cell 300 and includes a sleeve 301 acting as a housing, two electrodes 302 and 303, and a membrane 304 to produce ozone. In some embodiments, the sleeve applies a compressive force to the electrodes 302 and 303, and the membrane 304. During assembly, the two electrodes 302 and 303, and the membrane 304 inserted into the sleeve. In some exemplary embodiments, the sleeve 301 is made from an elastomeric material so that, once assembled, the sleeve 301 applies a constant force against the two electrodes 302 and 303, and the membrane 304. In this manner, the sleeve 301 provides structural integrity to the cell 300. This simple configuration has enabled the package size of the electrolytic cell 300 to be as small as 0.28″ by 0.28″ by 0.20″ [or, in metric terms, approximately 7.1 mm×7.1 mm×5.1 mm] although other embodiments may have different dimensions.

The sleeve 301 may have a variety of shapes in cross-section, including circular or oblong, or in the case of FIG. 3, rectangular. In some embodiments, an internal surface 306 of the sleeve 300 includes grooves 307. In the embodiment of FIG. 3, the grooves 307 are oriented such that they will be vertical with respect to the bottom 201 of a disinfecting chamber 200 when the electrolytic cell 300 is placed within the disinfecting chamber, as schematically illustrated in FIG. 2C, for example. Such grooves may facilitate the flow of water into and out-of the sleeve 300, and/or may facilitate the flow of hydrogen out of the sleeve 300.

In the embodiment of 300 of FIG. 3, the sleeve 301 is open at both ends, forming openings 301A and 301B, and may be described as a tube. In other embodiments, sleeve 301 may be closed at one end, or may have openings in other locations, such as sidewall 305 for example.

In operation, water from within the disinfecting chamber 200 may enter the sleeve through opening 301A, 301B, or both, or through another opening, and thereby come into contact with the electrodes 302 and 303. More particularly, the water may come into contact with one or more diamonds coupled to at least one of the electrodes 302 and 303. An electrode having such diamond may be referred to as a “diamond electrode,” as described more fully below. In some embodiments, only one electrode (e.g., 302) is a diamond electrode, while in other embodiments both electrodes (302, 302) are diamond electrodes. The diamond element is preferably doped to be conductive. For example, in some embodiments, the diamond element is doped with boron.

When provided with electrical power, current flows from a diamond electrode (which acts an anode) to the other electrode (which acts as a cathode), and water molecules at the electrode split into their constituent hydrogen and oxygen atoms. The oxygen atoms then form ozone, which dissolves into the remaining water, and the hydrogen atoms bubble away. As the dissolved ozone flows throughout the disinfecting chamber 200, some of the ozone comes into contact with a contact lens within the disinfecting chamber 200, thereby disinfecting the lens.

As described, the disinfecting ozone is formed within the disinfecting chamber 200, as opposed to being supplied to the disinfecting chamber from an external source. Specifically, the disinfecting ozone is created from the very water in which the contact lens is submerged. In some embodiments, the electrolytic cell 300 is configured within the disinfecting chamber 200 such that the electrolytic cell 300 will be completely submerged when water is placed within the disinfecting chamber 200, while in other embodiments the electrolytic cell 300 may be configured within the disinfecting chamber 200 such that the electrolytic cell 300 is only partially in contact with such water. Generally, it is sufficient that some water reach a diamond electrode.

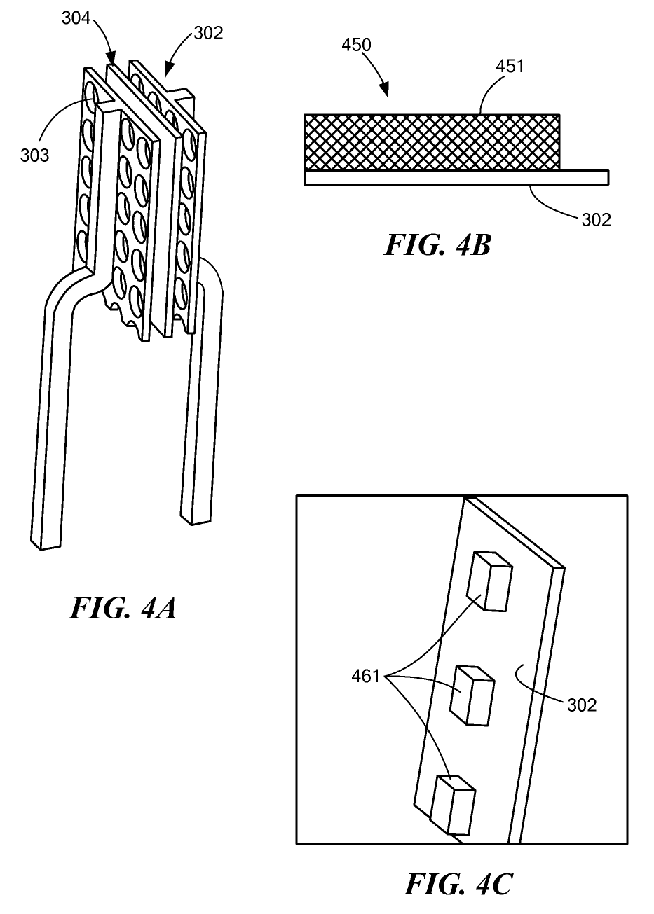

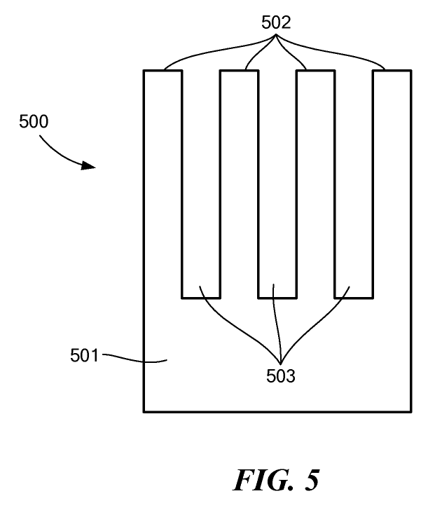

FIG. 4A schematically illustrates am embodiment of a pair of electrodes 302 and 303, and a membrane 304 between and separating electrodes 302 and 303. In some embodiments, the membrane 304 is sandwiched between the electrodes 302 and 303, between an electrode and a diamond, or between two diamond electrodes. The membrane 304 is used as a solid electrolyte and placed between the two electrodes 302 and 303 (e.g., a proton exchange membrane (PEM), such as Nafion®) to facilitate movement of protons between the electrodes 302 and 303. Additionally, in some cases, the membrane 304 is used as a barrier to separate water flow on the cathode side of the cell 300 from water on the anode side of the cell. To enhance its structural integrity, the membrane 304 may also include a supporting matrix (not shown).

The electrodes 302 and 303 by their very nature are electrically conductive, and in operation conduct electrical current to and from the power source 104. In operation, electrical current flows through a diamond element 500 coupled to an electrode.

An embodiment of a diamond electrode 450 is schematically illustrated in FIG. 4B, and includes a diamond element 451 and an electrode 302. In some embodiments, the diamond element may be a free-standing diamond as described in U.S. patent application Ser. No. 13/310,406, or may be a digitated diamond as schematically illustrated in FIG. 5. In other embodiments, however, the diamond may be a laminate diamond, such as a diamond grown on a conductive electrode plate.

As used herein and in any claim appended hereto, a “free-standing diamond” or “free-standing diamond element” is a non-laminated doped diamond material with a thickness of greater than about 100 microns. For example, the free-standing diamond may have a thickness of 100 microns, 200 microns, 300 microns, 400 microns or more. Indeed, some embodiment may have a thickness of 500 microns, 600 microns, 700 microns or more. Such thick diamonds are beneficially capable of carrying current at high current densities for sustained periods of time without a significant deterioration in performance, and without incurring substantial damage. For example, in some embodiments, the free-standing diamond is capable of conducting sustained current density of at least about 1 ampere (or “amp”) per square centimeter, while other embodiments are capable of conducting sustained current density of at least about 2 amperes per square centimeter, for example. During tests, the inventors have operated a free-standing diamond electrode at a current density of about 2 amperes per square centimeter for periods of at least about 500 continuous hours, without damaging the electrode or degrading its current carrying or ozone-producing performance. Such electrodes may produce more ozone per square centimeter of surface area than previously known electrodes, and may therefore be made more compact than a prior art electrode configured to produce the same amount of ozone per unit time. Electrodes according to various embodiments may also have longer useful and productive lifetimes than previously-known electrodes.

An alternate embodiment of a diamond electrode 460 is schematically illustrated in FIG. 4C. Diamond electrode 460 includes multiple diamond elements 461, each of which is box-shaped. While diamond elements 461 do not include fingers, each presents a number of edges, so that when the lengths of the edges summed, the diamond elements 461 have more total edge length than a single diamond element of equal top surface area.

In operation, water within the disinfecting chamber is in contact with a diamond electrode of an electrolytic cell 300. The voltage potential at the diamond electrode (i.e., the cathode) with respect to the other electrode (i.e., the anode) causes hydrogen atoms within individual water molecules to disassociate from the oxygen atoms.

In some embodiments, the power supply 104 is a current source that provides a fixed current to a diamond electrode 350. For example, the current may be fixed at 200 milliamps, at a DC voltage of between 7-9 volts across the electrodes 302 and 303. Other embodiments may use different current amplitudes, such as 150 milliamps or 300 milliamps or more, for example.

A variety of diamond elements may be used to form a diamond electrode. However, the inventors have discovered that ozone production tends to occur more readily at the edges of a diamond element. To that end, FIG. 5 schematically illustrates a plan view of an embodiment 500 of a diamond element configured for inclusion in a diamond electrode. The diamond element 500 includes a spine 501, and a number of fingers, or digits 502, extending from the spine 501. In this embodiment, the diamond element 500 has three fingers 502. Each finger is parallel to the others. A diamond having a two or more such fingers extending from a spine may be referred to as a “digitated diamond.”

Each finger has a number of edges that contribute to the total edge length (that is, the sum of the lengths of all the edges of a diamond element), and each finger has a surface area that contributes to the surface area of the diamond element. As such, the digitated diamond 500 has more edge length than a diamond element of equal size (e.g., equal surface area) but without fingers. In addition, the spaces 503 between the fingers 502 form a passage by which water may approach the diamond element 500, and through which hydrogen bubbles may move away from the diamond element 500. In operation, some embodiments orient the spaces 503 so that they are vertical with respect to the bottom 201 of a disinfecting chamber, so that hydrogen bubbles naturally tend to pass through the spaces 503 and move away from the diamond element 500.

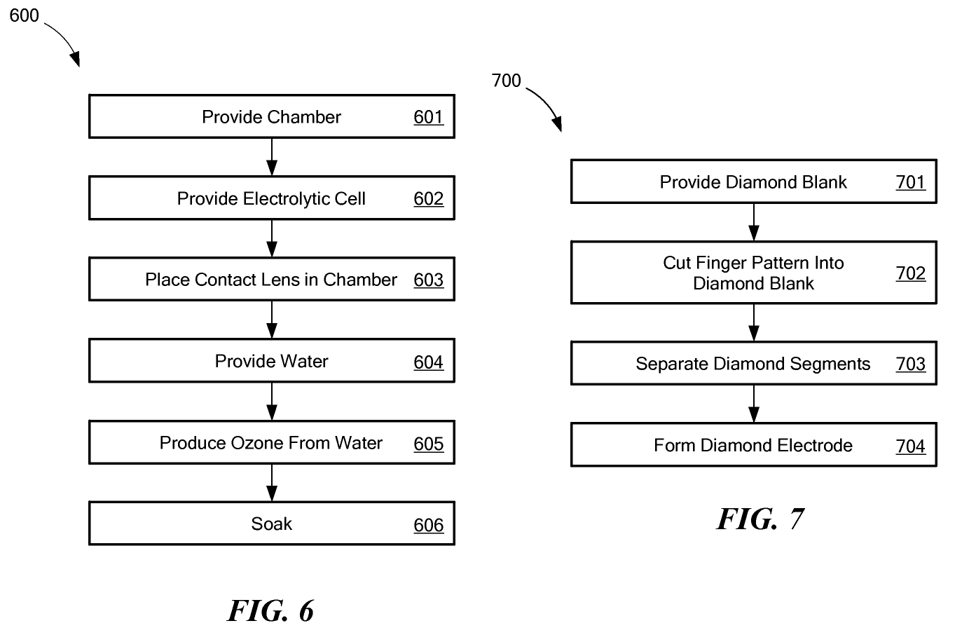

FIG. 6 illustrates a method 600 of disinfecting one or more contact lenses according to one embodiment. The method provides a disinfecting chamber at step 601. The disinfecting chamber may be the disinfecting chamber 200 described above, for example, or could take a variety of other configurations. Although the disinfecting chamber 200 described above is separable from the base 100, some embodiments may include a power supply and control circuitry integrated into a single unit with the disinfecting chamber.

The method also provides an electrolytic cell at step 602. In some embodiments, an electrolytic cell may come with, or be integral with, a disinfecting chamber. In other embodiments, an electrolytic cell may be removably coupled with a disinfecting chamber, so that the electrolytic cell may be removed and replaced separately from the disinfecting chamber. As such, the electrolytic cell may be supplied with, or separately from, providing the disinfecting chamber.

One or more contact lenses to be cleaned are put into the disinfecting chamber at step 604, and water is supplied into the disinfecting chamber at step 604, although the order of these two steps may be readily reversed.

At this point, the equipment and materials necessary to clean the contact lens is in place. The process then energizes the electrolytic cell to produce ozone at step 605. In some embodiments, ozone is produced by driving a constant current through diamond electrode. For example, some embodiments drive a current of 200 milliamps through a diamond electrode (anode) in an electrolytic cell, in which there is a voltage difference of about 7 to 9 volts between the diamond anode and a cathode, for a period of about 6 minutes. The water is captive within the disinfecting chamber, and so the concentration of ozone within the water has time to build-up to a specified level. As such, the electrolytic cell produces ozone for 6 minutes, and the ozone dissolves in the water to produce a water-ozone solution.

Thereafter, some embodiments soak the contact lens in the water-ozone solution for a pre-determined amount of time (step 606), during which time additional ozone is not being produced or added to the water. In some embodiments, the soak time may be 14 minutes, although other embodiments may have longer or shorter soak times. The soak time allows the ozone to disinfect the lens, and also provides time for the water and lens to cool down, if necessary. Nevertheless, other embodiments may drive different currents, or supply a different voltage, or for a different amount of time. The ozone creation time and the soak time may be referred to, collectively, as a “disinfecting cycle.”

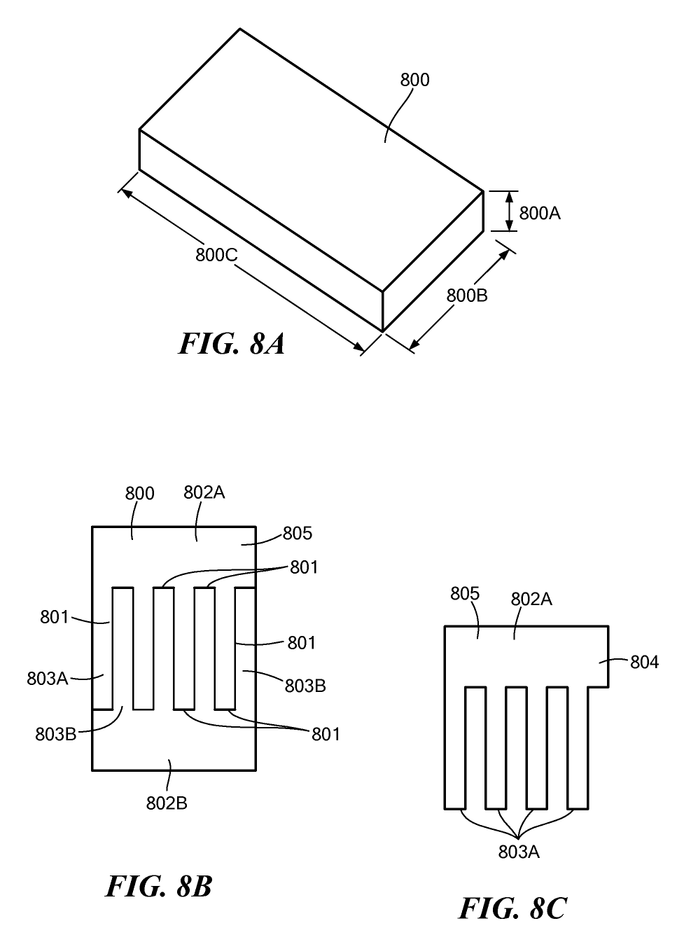

FIG. 7 illustrates a method 700 of fabricating a digitated diamond element, and FIGS. 8A-C schematically illustrate a digitated diamond element at various stages of fabrication. The process may optionally also use a digitated diamond to form a diamond electrode.

The method begins at step 701 by supplying a diamond blank 800. A diamond blank 800 may take a variety of shapes and have a variety of dimensions, provided that the shape and dimensions are sufficient to yield a digitated diamond.

In this embodiment, the diamond blank 800 has 6 rectangular faces, and has a thickness 800A, a width 800B, and a length 800C. In some embodiments, the thickness 800A of the blank 800 may be less than 100 microns. In other embodiments however, the thickness may be equal to or greater than 100 microns, and may even be 200 microns, 300 microns, 400 microns, 500 microns, 600 microns, 700 microns, or more. The width 800B and length 800C of the blank 800 may be determined by the desired dimensions of the diamond elements to be produced.

In this embodiment, the method 700 will produce two identical digitated diamonds from the diamond blank 800, although other embodiments may produce only one, or more than two, digitated diamonds from a single blank, depending on the dimensions of the blank and the desired digitated diamond elements.

To that end, the process cuts a zig-zag or serpentine line 801 into and through the blank 800 at step 702. Such a line 801 may be cut through the diamond blank by a laser beam, for example.

The pattern of zig-zag or serpentine line 801 produces a set of interdigitated fingers 803A and 803B as schematically illustrated in FIG. 8B. Each set of interdigitated fingers 803A and 803B remains connected to a respective portion of the blank 800, which portion forms the spine of each digitated diamond. For example, in this embodiment, fingers 803A are connected to spine 802A, and fingers 803B remain connected to spine 802B.

After the line 801 is cut through the blank 800, the two digitated diamonds are separated at step 703. As such, the blank 800 in this embodiment has been cut into two identical digitated diamonds. One of those digitated diamonds 805 is schematically illustrated in FIG. 8C. Note that digitated diamond 805 includes a tab 804 that is an artifact resulting from the cutting process described above. This tab 804 may be beneficial in that it increases the surface area of the digitated diamond 805, thereby increasing the surface area available to interface with an electrode, such as electrode 302. However, tab 804 may optionally be removed or cut off, to produce a digitated diamond 500 as schematically illustrated in FIG. 5.

A digitated diamond 805 may optionally be coupled to an electrode to form a diamond electrode at step 704. Alternately, the diamond electrode may be used or provided to a third party for similar or other applications.

The control circuit 103 may take a variety of forms and may be configured, or configurable, to perform a variety of functions. Some embodiments of the power circuitry are configured to controllably or automatically reverse the polarity of the power supplied to the electrodes of an electrolytic cell. For example, an electrolytic cell may have two diamond electrodes. In a first phase, one of the diamond electrodes may be coupled to the power supply and thereby act as an anode, while the other diamond electrode is coupled to the power supply to act as the cathode.

In operation, scale may begin to build-up, or continue to build-up. As such, some embodiments reverse the polarity of the power supplied to the electrodes, to reverse the conditions that cause the scale build-up at the electrodes. Indeed, reversing the polarity of the applied power may even cause existing scale to dissipate. Therefore, some embodiments reverse the polarity of the power on a periodic basis during a disinfection operation. Alternately, a power circuit may be configured to apply power in a first polarity in a first use of the disinfecting system, and to apply the opposite or reverse polarity during the next use of the disinfecting system.

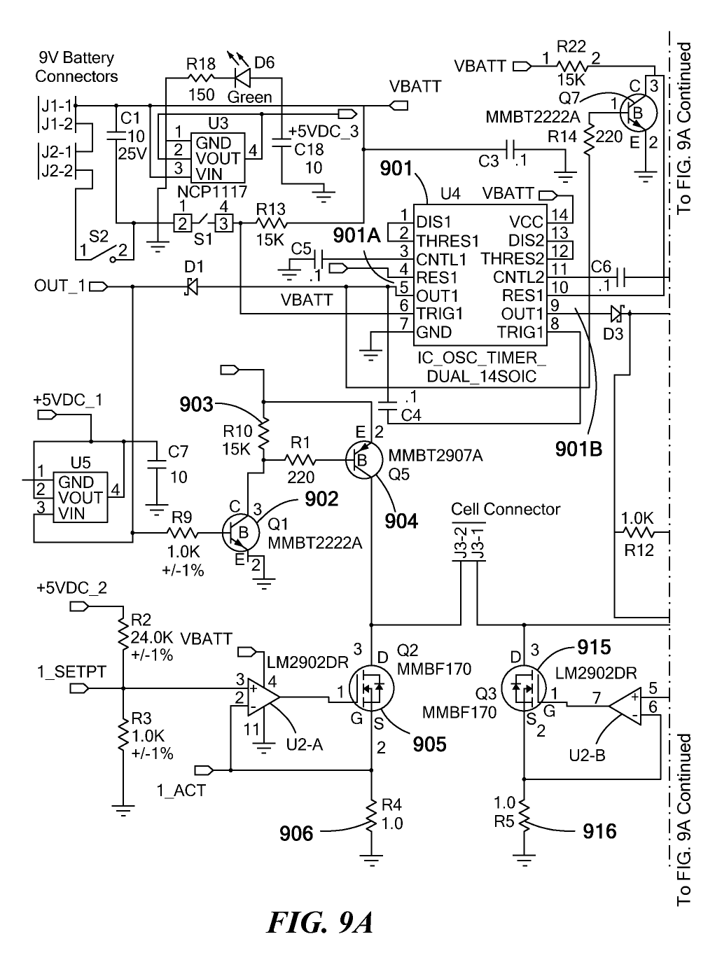

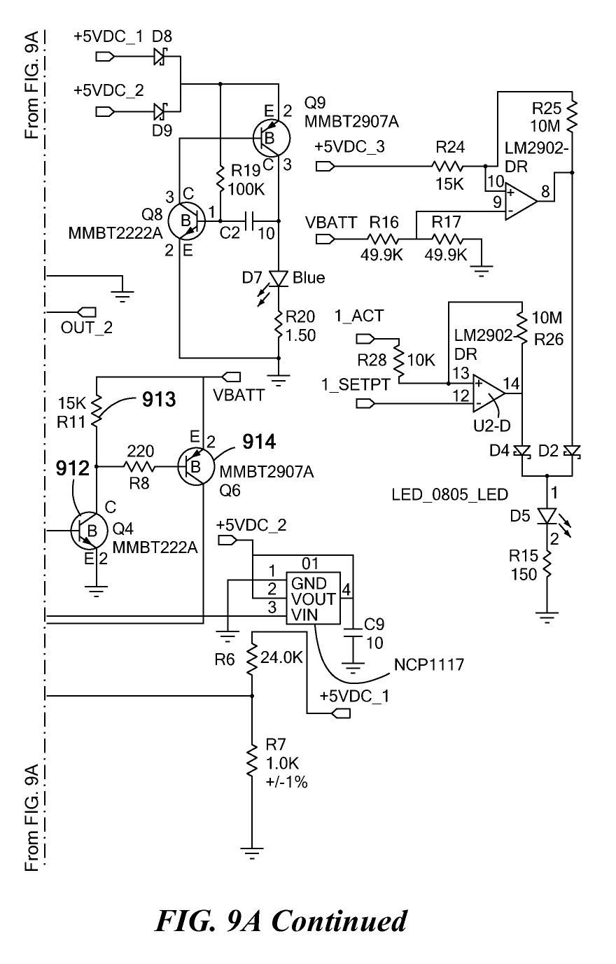

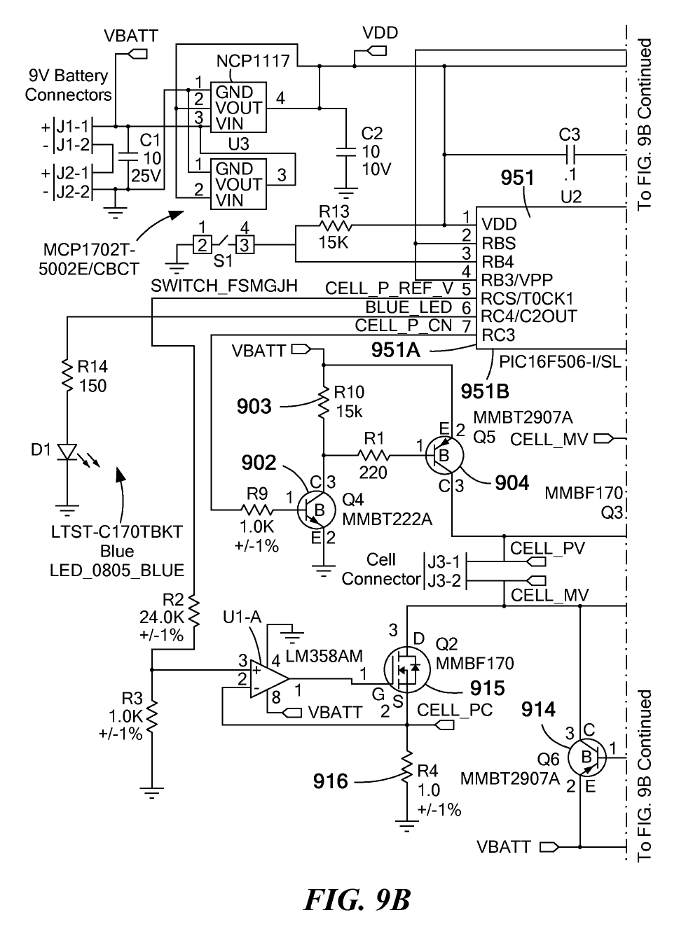

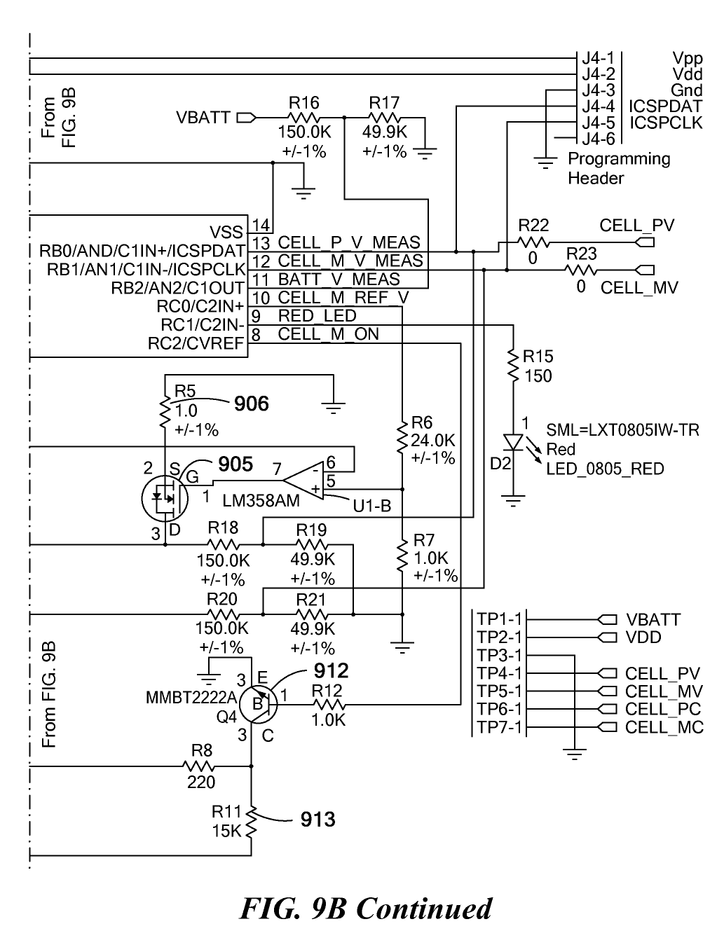

An embodiment of a polarity reversing power circuit 900 is schematically illustrated in FIG. 9A. It should be noted that the arrangement and values of the components in circuit 900 are illustrative, and not intended to limit all embodiments.

The polarity reversing power circuit 900 has two power branches, where each is coupled to one of the electrodes of an electrolytic cell. In a first mode, a first branch supplies power to one of the electrodes, which then acts as the anode, and the second branch is coupled to the second electrode, which acts as the cathode. Later, the roles of the two branches are reversed, such that the second branch supplies power to the second electrode, which then acts as the anode, and the first branch is coupled to the first electrode, which acts as the cathode. In FIG. 9A, the two branches are controlled by a conventional dual 555 timer 901 (also known as a 556 timer). That timer may be referred to as a timing and control sub-circuit.

In operation in a first polarity mode, timer 901 produces a first output signal on a first output pin 901A and supplies that first output signal to a first branch of the circuit 900. The first output signal causes transistor 902 to conduct current, which pulls current through resistor 903 and transistor 904.

Some of the current through transistor 904 flows through transistor 905, and the remainder of that current flows to an electrode 302 of an electrolytic cell (not shown in FIG. 9A) as discussed above. The transistor 905 is biased to draw a fixed amount of current and to supply that current to resistor 906. As such, the voltage drop across transistor 905 and resistor 906 sets the voltage at the node between transistors 904 and 905, which is the voltage at the electrode 302. That voltage may be between 7 and 9 volts, and the current delivered to the electrode 302 may be 200 mA. Indeed, in some embodiments the voltages and currents may be different. For example, in some embodiments, the current may be 150 milliamps, or 250 or 300 milliamps, or a different amount of current.

The timer 901 also produces a second output signal on a second output pin 901B, and supplies that second output signal to the second branch of the circuit. The second branch of the circuit includes transistors 912, 914 and 915, and resistor 913 and 916, which correspond to transistors 902, 904 and 905, and resistor 903 and 906 respectively in the first branch of circuit 900.

In a first polarity mode, the second output signal from pin 901B is low enough that it does not cause transistor 912 to conduct, and therefore transistor 913 does not supply current to transistor 915. However, current flowing from the electrolytic cell on electrode 303 will flow through transistor 915 and resistor 916, to ground.

In a second, or “reverse polarity” mode, the operation of the two branches of circuit 900 is reversed. Timer 901 essentially reverses the signals on outputs 901A and 901B from those described above. As such, transistors 912, 914 and 915, and resistor 913 and 916 (in the second branch of circuit 900) are active and supply current to electrode 303, while transistors 902, 904 and 905, and resistor 903 and 906 (in the first branch of circuit 900) sink the current exiting the electrolytic cell.

An alternate embodiment of a polarity reversing power circuit 950 is schematically illustrated in FIG. 9B. The circuit 950 includes a first and second branch as described above for circuit 900. However, circuit 950 does not include a dual 555 timer. Rather, the timing and control sub-circuit in circuit 950 is a microprocessor or microcontroller 951. In the embodiment of FIG. 9B, the microcontroller 951 is a PIC16F506-ISL microcontroller, available from Microchip Technology. Indeed, a variety of other microprocessors or microcontrollers could be used in other embodiments.

The microcontroller 951 has a number of pins, including output pins 951A and 951B. Output pins 951A and 951B produce the signals that control the two branches of circuit 901, as described above, and the branches respond and operate essentially as described above in connection with circuit 900.

The microprocessor or microcontroller 951 is programmed with program code to control the two branches of the circuit 950 to controllably reverse the polarity of the power provided to the electrolytic cell. For example, the power may be reversed periodically during a cleaning cycle, reversed on a pre-determined schedule, or even randomly over time. In some embodiments, the polarity of the power remains fixed when the system is in operation, and is reversed when the system is next operated.

As described above, illustrative embodiments do not include a reservoir of, or use, a catholyte solution. This is so because the inventors have recognized that, although catholyte solution helps prevent the build-up of scale in electrolytic cells, it also requires the use of additional parts and would add to the cost of the electrolytic cell and/or a system using such an electrolytic cell. The inventors further recognized that, in illustrative embodiments, the disadvantages associated with scale build up are outweighed by the simple and economical design of various embodiments of an electrolytic cell and disinfecting systems. This economical and simple design of the cell allows for it to be replaced once it is no longer efficient.

Although the circuits and methods described above describe a constant current supplied to an electrolytic cell, alternate embodiments may provide power in a variety of ways. For example, some embodiments may include a power circuit that delivers current only to a single electrode of an electrolytic cell, although such embodiments would not be able reverse the polarity of the supplied power. Other embodiments may provide a controlled voltage to the electrolytic cell rather than a controlled current. Yet other embodiments may provide controlled but variable or varying currents or voltages to an electrolytic cell.

Although the embodiments described above illustrate only a single electrolytic cell in a disinfecting chamber, some embodiments may provide two or more electrolytic cells in a disinfecting chambers. Multiple electrolytic cells may produce ozone more quickly than a single electrolytic cell operating alone, and may therefore reduce the time required to disinfect a contact lens.

In addition, although the embodiment described above illustrate systems and methods for disinfecting one or more contact lenses, the systems and methods could also be used to disinfect other items small enough to fit into the disinfecting chamber.

Further, although the liquid in which the electrolytic cell operates has been illustratively described as water, some embodiments use other water-based liquid. For example, saline solutions such as those commonly available for use in cleaning contact lenses may be used in place of water. However, it should be noted that various embodiments described herein are capable of disinfecting one or more contact lenses by creating ozone from water alone (e.g., without needing salt or other molecules in the water).

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transient computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method of disinfecting a contact lens, the method comprising:
providing a chamber configured to hold a water-based liquid and to hold at least one contact lens, and configured to supply power to an electrolytic cell;
providing water within the chamber;
providing an electrolytic cell at least partially submerged in the water; and
causing the electrolytic cell to produce ozone from at least a portion the water, the ozone dissolving in the water.

2. The method of disinfecting a contact lens according to claim 1, wherein providing an electrolytic cell comprises providing an electrolytic cell comprising a first diamond electrode and a second electrode, and a membrane separating the first diamond electrode and the second electrode.

3. The method of disinfecting a contact lens according to claim 2, wherein causing the electrolytic cell to produce ozone from at least a portion the water comprises driving a constant current between the first diamond electrode and the second electrode.

4. The method of disinfecting a contact lens according to claim 3, wherein the current is between about 150 and 300 milliamps, and the voltage potential between the electrodes is between about 7 and 9 volts.

5. The method of disinfecting a contact lens according to claim 1, wherein providing an electrolytic cell comprises providing an electrolytic cell comprising a first diamond electrode and a second diamond electrode, and a membrane separating the first diamond electrode and the second electrode.

6. The method of disinfecting a contact lens according to claim 5, wherein causing the electrolytic cell to produce ozone from at least a portion the water comprises driving a constant current between the first diamond electrode and the second diamond electrode.

7. The method of disinfecting a contact lens according to claim 6, wherein the current is between about 50 and 300 milliamps, and the voltage potential between the electrodes is between 7 and 9 volts.

8. The method of disinfecting a contact lens according to claim 6, wherein driving a constant current between the first diamond electrode and the second diamond electrode further comprises periodically reversing the direction of the current flow.

9. The method of disinfecting a contact lens according to claim 1, the method further comprising placing a contact lens into the chamber.

10. A system for disinfecting a contact lens by creating ozone in water within a disinfecting chamber, the system comprising:
a chamber configured for holding a water-based liquid and at least one contact lens;
an electrolytic cell within the chamber and configured to be submerged in the water-based liquid, wherein the electrolytic cell comprises a first electrode and a second electrode, at least one of the first electrode and the second electrode comprising a diamond, the electrolytic cell configured to produce ozone from the water-based liquid; and
a plurality of chamber power terminals within the chamber, the plurality of power terminals coupled to the electrolytic cell,
wherein the relationship between the volume of the chamber and the ozone-producing capacity of the electrolytic cell is such that the electrolytic cell is capable of producing a concentration of ozone with the water-based liquid of at least 0.5 parts per million.

11. The system for disinfecting a contact lens according to claim 10, wherein at least one of the first electrode and the second electrode comprises a free-standing diamond.

12. The system for disinfecting a contact lens according to claim 10, wherein at least one of the first electrode and the second electrode comprises a digitated diamond.

13. The system for disinfecting a contact lens according to claim 11, wherein the electrolytic cell comprises a first diamond electrode and a second diamond electrode.

14. The system for disinfecting a contact lens according to claim 13, where in the first diamond electrode comprises a first digitated diamond and the second diamond electrode comprises a second digitated diamond.

15. The system for disinfecting a contact lens according to claim 10, the system further comprising a power source coupled to the plurality of chamber power terminals, the power source configured to supply power to the electrolytic cell via the plurality of chamber power terminals.

16. The system for disinfecting a contact lens according to claim 15, wherein the power source is configured to supply a constant current to the electrolytic cell.

17. The system for disinfecting a contact lens according to claim 16, wherein the constant current is between 50 and 300 milliamps.

18. The system for disinfecting a contact lens according to claim 10, the system further comprising a base configured to receive the chamber, the base including a plurality of base power terminals configured to electrically connect to the chamber power terminals, and including control circuitry configured to supply power to the base power terminals.

19. A method of fabricating a diamond, the method comprising:
providing a diamond blank having a plurality of faces;
removing at least a portion of the diamond blank, such that the remaining portion of the diamond blank comprises a plurality of fingers.

20. The method of fabricating a diamond according to claim 20, wherein removing at least a portion of the diamond blank comprises:
cutting the diamond blank into a first segment and a second segment, the first segment having a first plurality of fingers and the second segment having a second plurality of fingers, the first plurality of fingers interdigitated with the second plurality of fingers; and
separating the first segment from the second segment.

21. The method of fabricating a diamond according to claim 20, wherein removing at least a portion of the diamond blank comprises removing at least a portion of the diamond blank such that the remaining portion of the diamond blank comprises at least three fingers.
